(19) United States
(12) Patent Application Publication
(10) Pub. No.: US 2010/0169799 A1
(43) Pub. Date: Jul. 1, 2010

(54) Method and Apparatus for Enabling Presentations to Large Numbers of Users in a Virtual Environment

(75) Inventors: Arn Hyndman, Ottawa (CA); Albert Reiche, Kanata (CA); Nicholas Sauriol, Ottawa (CA)

Correspondence Address: Anderson Gorecki & Manaras, LLP;Attn: John C. Gorecki, P.O BOX 553, CARLISLE, MA, 01741, US

(73) Assignee: Nortel Networks Limited, St. Laurent (CA)

(21) Appl. No.: 12/345,926

(22) Filed: Dec. 30, 2008

(51) Int. Cl. G06F 3/048

(52) U.S. Cl. 715/757; 718/1

(57) ABSTRACT

A method and apparatus for enabling interaction with a large number of participants in a three dimensional computer-generated virtual environment is provided. In one embodiment, a participant in a three dimensional computer-generated virtual environment is able to simultaneously exist in multiple areas of a sliced virtual environment or in multiple instances of an instanced virtual environment. In this embodiment, the user's Avatar is replicated across the multiple regions/instances to simultaneously appear to users supported by multiple servers. Since users on multiple servers are able to see and hear the replicated Avatar, the virtual environment may be used to present information to a larger number of users than would be able to see the presenter's Avatar in the virtual environment hosted by a single virtual environment server.

### CROSS-REFERENCE TO RELATED APPLICATIONS

None

### BACKGROUND OF THE INVENTION

1. Field of the Invention

The present invention relates to virtual environments and, more particularly, to a method and apparatus for enabling presentations to large numbers of users in a virtual environment.

2. Description of the Related Art

Virtual environments simulate actual or fantasy two dimensional and three dimensional environments and allow for many participants to interact with each other and with constructs in the environment via remotely-located clients. One context in which a virtual environment may be used is in connection with gaming, although other uses for virtual environments are also being developed.

In a virtual environment, an actual or fantasy universe is simulated within a computer processor/memory. Multiple people may participate in the virtual environment through a computer network, such as a local area network or a wide area network such as the Internet. Each player selects an “Avatar” which is often a three-dimensional representation of a person or other object to represent them in the virtual environment. Participants send commands to a virtual environment server that controls the virtual environment to cause their Avatars to move within the virtual environment. In this way, the participants are able to cause their Avatars to interact with other Avatars and other objects in the virtual environment.

A virtual environment often takes the form of a virtual-reality three dimensional map, and may include rooms, outdoor areas, and other representations of environments commonly experienced in the physical world. The virtual environment may also include multiple objects, people, animals, robots, Avatars, robot Avatars, spatial elements, and objects/environments that allow Avatars to participate in activities. Participants establish a presence in the virtual environment via a virtual environment client on their computer, through which they can create an Avatar and then cause the Avatar to “live” within the virtual environment.

As the Avatar moves within the virtual environment, the view experienced by the Avatar changes according to where the Avatar is located within the virtual environment. The views may be displayed to the participant so that the participant controlling the Avatar may see what the Avatar is seeing. Additionally, many virtual environments enable the participant to toggle to a different point of view, such as from a vantage point outside of the Avatar, to see where the Avatar is in the virtual environment.

The participant may control the Avatar using conventional input devices, such as a computer mouse and keyboard. The inputs are sent to the virtual environment client which forwards the commands to one or more virtual environment servers that are controlling the virtual environment and providing a representation of the virtual environment to the participant via a display associated with the participant's computer.

Depending on how the virtual environment is set up, an Avatar may be able to observe the environment and optionally also interact with other Avatars, modeled objects within the virtual environment, robotic objects within the virtual environment, or the environment itself (i.e. an Avatar may be allowed to go for a swim in a lake or river in the virtual environment). In these cases, client control input may be permitted to cause changes in the modeled objects, such as moving other objects, opening doors, and so forth, which optionally may then be experienced by other Avatars within the virtual environment.

“Interaction” by an Avatar with another modeled object in a virtual environment means that the virtual environment server simulates an interaction in the modeled environment, in response to receiving client control input for the Avatar. Interactions by one Avatar with any other Avatar, object, the environment or automated or robotic Avatars may, in some cases, result in outcomes that may affect or otherwise be observed or experienced by other Avatars, objects, the environment, and automated or robotic Avatars within the virtual environment.

A virtual environment may be created for the user, but more commonly the virtual environment may be persistent, in which it continues to exist and be supported by the virtual environment server even when the user is not interacting with the virtual environment. Thus, where there is more than one user of a virtual environment, the environment may continue to evolve when a user is not logged in, such that the next time the user enters the virtual environment it may be changed from what it looked like the previous time.

Virtual environments are commonly used in on-line gaming, such as for example in online role playing games where users assume the role of a character and take control over most of that character's actions. In addition to games, virtual environments are also being used to simulate real life environments to provide an interface for users that will enable on-line education, training, shopping, and other types of interactions between groups of users and between businesses and users.

As Avatars encounter other Avatars within the virtual environment, the participants represented by the Avatars may elect to communicate with each other. For example, the participants may communicate with each other by typing messages to each other audio may be exchanged so that the participants can talk with each other.

A virtual environment is maintained by one or more a virtual environment servers. Since virtual environment servers have finite processing capacity and finite bandwidth, there is a limit on the number of users that may access a virtual environment through a particular server. For example, the virtual environment server is responsible for providing data to the users and mixing audio for users of the virtual environment. The user's avatar is not only visible to the user, but also may be visible to other users depending on the location of their Avatars within the virtual environment. This may be processor intensive, which limits the number of users that can simultaneously access a virtual environment through a particular virtual environment server. Where the number of users that would like to access the virtual environment exceeds the capacity of an individual server, the users will be allocated between different virtual environment servers.

There are two common ways to allocate users between virtual environment servers. A first way will be referred to herein as “instancing”. Where instancing is used, the virtual environment servers each maintain a full “instance” of the entire virtual environment world, and some of the users are allocated to each of the virtual environment servers. This has the benefit of enabling each user to have access to the entire virtual environment, but limits the number of people that may interact with each other. Specifically, this results in parallel worlds which may evolve differently. Users in one of the parallel worlds are not affected by Avatars in other parallel worlds.

Instancing may have the added benefit of enabling the server to selectively support users that are geographically close (in a network sense) to the server. For example, a server in North America may be used to support users in North America while a server in Europe may be used to support users in Europe. This results in lower latency on the network and, thus, a better experience for everyone on the instance.

Virtual world clients are also limited in how many Avatars they can render and the bandwidth available to send information to the client about other Avatars is also limited. So, in some cases, the client may use a virtual geographical system to limit its load (e.g. show only Avatars within × feet of my Avatar—other strategies also exist). This enables the client to reduce the amount of information that it is required to process, and may be performed in addition to instancing/slicing at the server.

An alternative way of sharing users between servers is to cause each of the servers to be responsible for users within a particular area of the virtual environment. This will be referred to herein as “slicing”. Slicing requires responsibility for users to be handed off from one server to the next when a user moves within regions of the virtual environment. This has the advantage of maintaining a single virtual world. However, since each server can only handle a particular number of users, the number of users that may be present in a given area of the world at a particular time is limited by the processing power of the server hosting that area of the virtual environment. Thus, users may be denied access to particular areas of the virtual environment if that area is crowded.

Slicing may be viewed in some ways as inferior to instancing, since instancing gives the user a better feel for the overall virtual environment and also enables the server placement to better match network topography and be adjusted to coincide with concentrations of users of the virtual environment.

Regardless of whether instancing or slicing is used to host the virtual environment, the number of users that may be present and interact with each other at any point in time in a virtual environment is limited. Where instancing is used, the several servers will maintain parallel virtual environments such that a person in one instance of the virtual environment will not see users in other instances of the virtual environments. Since each server is limited to hosting a particular number of Avatars, more than that fixed number of Avatars cannot directly interact with each other. Similarly, where slicing is used, the number of users in a given area is limited such that only a subset of the users in the virtual environment may be present at one place at a given point in time. Thus, once again, the number of Avatars that may interact with each other is limited by the particular processing power of the virtual environment server.

There are times when it would be advantageous to present information to a large number of people. For example, a politician may want to give a speech to a large gathering of people, or a company president may want to make an announcement to all of the employees of the company. Similarly, a trade industry may want to host a trade show in a virtual environment and enable members to make presentations to the assembly of trade show participants. Unfortunately, since the number of users that may be present in a particular area of a virtual environment is limited, this limitation makes virtual environments unsuitable for such large scale presentations. Accordingly, it would be advantageous to enable interaction with a large number of participants in a virtual environment.

### SUMMARY OF THE INVENTION

A method and apparatus for enabling interaction with a large number of participants in a computer-generated virtual environment is provided. In one embodiment, a participant in a computer-generated virtual environment is able to simultaneously exist in multiple areas of a sliced virtual environment or in multiple instances of an instanced virtual environment. In this embodiment, the user's Avatar is replicated across the multiple regions/instances to simultaneously appear to users supported by multiple servers. Since users on multiple servers are able to see and hear the replicated Avatar, the virtual environment may be used to present information to a larger number of users than would be able to see the presenter's Avatar in the virtual environment hosted by a single virtual environment server.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of a portion of an example system enabling users to have access to computer-generated virtual environment;

FIG. 2 is a view of an example Avatar appearing on a display as part of a computer-generated virtual environment;

FIG. 3A is a two dimensional view of users in an example computer-generated virtual environment implemented using multiple servers, each of which is responsible for users in a particular region of the virtual environment;

FIG. 3B is a two dimensional view of the example of FIG. 2 showing a replication zone located within each zone of the virtual environment;

FIG. 4 is a two dimensional view of users in an example computer-generated virtual environment implemented using multiple servers, each of which is responsible for maintaining a full instance of the virtual environment and a subset of the total users of the virtual environment;

FIG. 5 is a two dimensional view of the example of FIG. 4 showing a replication zone located within each instance of the virtual environment;

FIGS. 6 and 7 show an example computer-generated virtual environment representing an auditorium, in which two servers are responsible for different regions of the auditorium, and in which two replication zones are implemented;

FIGS. 8 and 9 show an example computer-generated virtual environment representing an auditorium, in which two servers are responsible for implementing a full instance of the auditorium and a subset of the total users of the virtual environment;

FIG. 10 is a flow diagram of a process that may be used to enable an Avatar to be visible in multiple instances/areas of a virtual environment according to an embodiment; and

FIG. 11 is a functional block diagram showing components of the system of FIG. 1 interacting to enable objects and Avatars to be replicated between instances or regions of a computer-generated virtual environment according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

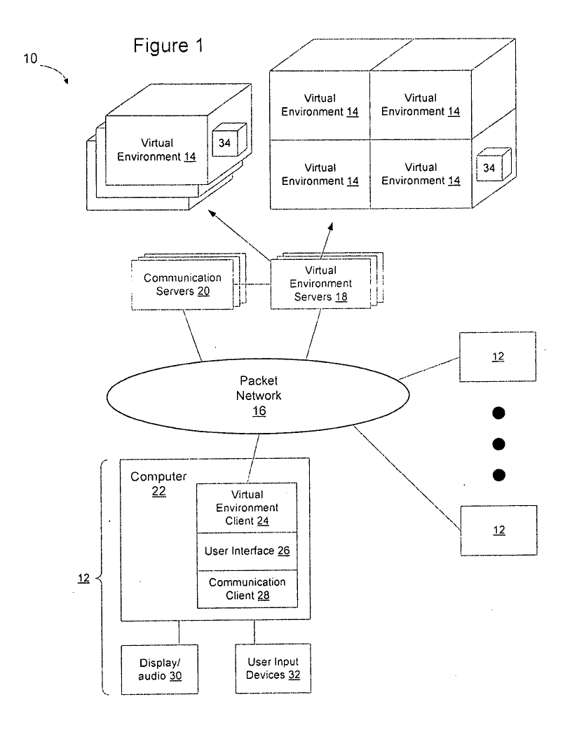

FIG. 1 shows a portion of an example system 10 showing the interaction between a plurality of users 12 and one or more virtual environments 14. A user may access the virtual environment 14 from their computer 22 over a packet network 16 or other common communication infrastructure. The virtual environment 14 is implemented by one or more virtual environment servers 18. Communication sessions such as audio calls between the users 12 may be implemented by one or more communication servers 20.

The virtual environment may be implemented as using one or more instances, each of which may be hosted by one or more virtual or physical environment servers. Where there are multiple instances, the Avatars in one instance are generally unaware of Avatars in the other instance. Conventionally, each instance of the virtual environment may be referred to as a separate World. A world may be implemented by one virtual environment server 18, or may be implemented by multiple virtual environment servers.

According to an embodiment of the invention, as described in greater detail below, a replication zone may be defined within the virtual environment. The replication zone will enable objects and Avatars that enter the replication zone to be present in each instance of the virtual environment that also incorporates an associated replication zone. Thus, when an Avatar enters the replication zone, the Avatar is visible to users in multiple instances, and preferably all instances, of the virtual environment. Similarly, where different slices of the virtual environment are supported by different servers, the replication zone can exist in each of the slices such that the Avatar and other objects within the replication zone are visible to different sets of users at different locations within the virtual environment. This enables a single Avatar to interact with and be visible to a larger group of Avatars/users than would otherwise be possible.

The virtual environment 14 may be any type of virtual environment, such as a virtual environment created for an on-line game, a virtual environment created to implement an on-line store, a virtual environment created to implement an on-line training facility, or for any other purpose. Virtual environments are being created for many reasons, and may be designed to enable user interaction to achieve a particular purpose. Example uses of virtual environments include gaming, business, retail, training, social networking, and many other aspects.

Generally, a three-dimensional virtual environment will have its own distinct three dimensional coordinate space. Avatars representing users may move within the three dimensional coordinate space and interact with objects and other Avatars within the three dimensional coordinate space. The virtual environment servers maintain the virtual environment and passes data to the user's virtual environment client, which generates a visual presentation for the user based on the location of the user's Avatar within the virtual environment. The view may also depend on the direction in which the Avatar is facing and the selected viewing option, such as whether the user has opted to have the view appear as if the user was looking through the eyes of the Avatar, or whether the user has opted to pan back from the Avatar to see a panoramic view of where the Avatar is located and what the Avatar is doing in the computer-generated virtual environment.

Each user 12 has a computer 22 that may be used to access the computer-generated virtual environment. The computer 22 will run a virtual environment client 24 and a user interface 26 to the virtual environment. The user interface 26 may be part of the virtual environment client 24 or implemented as a separate process. A separate virtual environment client may be required for each virtual environment that the user would like to access, although a particular virtual environment client may be designed to interface with multiple virtual environment servers. A communication client 28 is provided to enable the user to communicate with other users who are also participating in the three dimensional computer-generated virtual environment. The communication client may be part of the virtual environment client 24, the user interface 26, or may be a separate process running on the computer 22.

The user may see a representation of a portion of the computer-generated virtual environment on a display/audio 30 and input commands via a user input device 32 such as a mouse, touch pad, or keyboard. The display/audio 30 may be used by the user to transmit/receive audio information while engaged in the virtual environment. For example, the display/audio 30 may be a display screen having a speaker and a microphone. The user interface generates the output shown on the display 30 under the control of the virtual environment client 24, and receives the input from the user via the user input device 32 and passes the user input to the virtual environment client. The virtual environment client passes the user input to the virtual environment server 18 which causes the user's Avatar 34 or other object under the control of the user to execute the desired action in the virtual environment 14. In this way the user may control a portion of the virtual environment, such as the person's Avatar or other objects in contact with the Avatar, to change the virtual environment for the other users of the virtual environment.

Typically, an Avatar is a three dimensional rendering of a person or other creature that represents the user in the virtual environment. The user selects the way that their Avatar looks when creating a profile for the virtual environment and then can control the movement of the Avatar in the virtual environment such as by causing the Avatar to walk, run, wave, talk, or make other similar movements. Thus, the block 34 representing the Avatar in the virtual environment 14, is not intended to show how an Avatar would be expected to appear in a virtual environment. Rather, the actual appearance of the Avatar is immaterial since the actual appearance of each user's Avatar may be expected to be somewhat different and customized according to the preferences of that user. Since the actual appearance of the Avatars in the three dimensional computer-generated virtual environment is not important to the concepts discussed herein, Avatars have been represented using simple geometric shapes such as cubes and diamonds rather than complex three dimensional shapes such as people and animals.

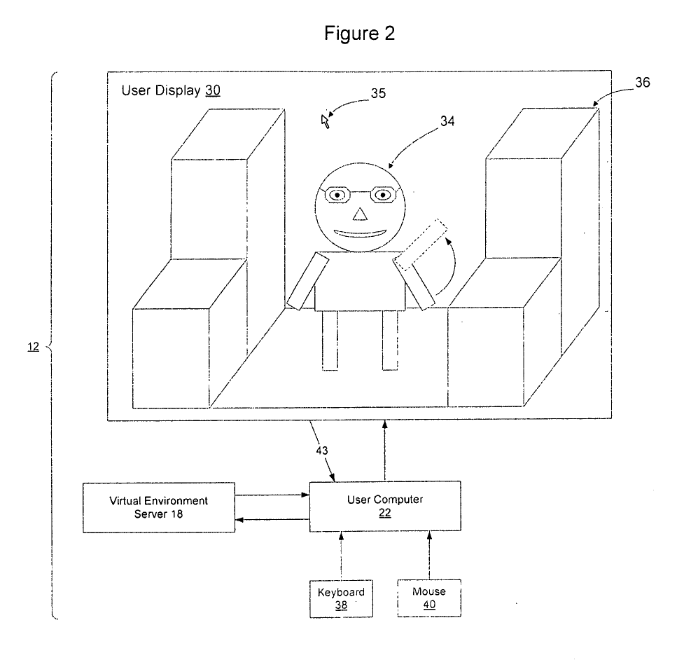

FIG. 2 shows the display in greater detail. As shown in FIG. 2, the user display will generally include a three dimensional computer-generated virtual environment 36 within which the user's Avatar 34 may move and interact with objects and other Avatars. A simplified Avatar has been shown in this figure for simplicity of illustration. Actual Avatars are generally three dimensional representations of humans or other creatures rather than simple line drawings.

In the example shown in FIG. 2, the user's computer 22 interacts with the virtual environment server 18 to receive information related to the virtual environment 36, the Avatar within the virtual environment, and to enable the user to control the Avatar in the virtual environment and, hence, on the computer display 30. The VE client then renders the user's view of the virtual environment. If other users of the virtual environment are present in the virtual environment, they may also be able to see the user's Avatar depending on their location within the virtual environment and their point of view in the virtual environment.

The user may control the Avatar by controlling its motions. Commonly, for example, a user would point his mouse cursor 35 where he wanted the Avatar to go using mouse 40. Other common ways to control an Avatar include use of arrow keys or letters such as WASD on the keyboard 38, and combinations of keyboard keys and mouse movement. Many different ways of controlling gaming environments and other types of virtual environments have been developed over time.

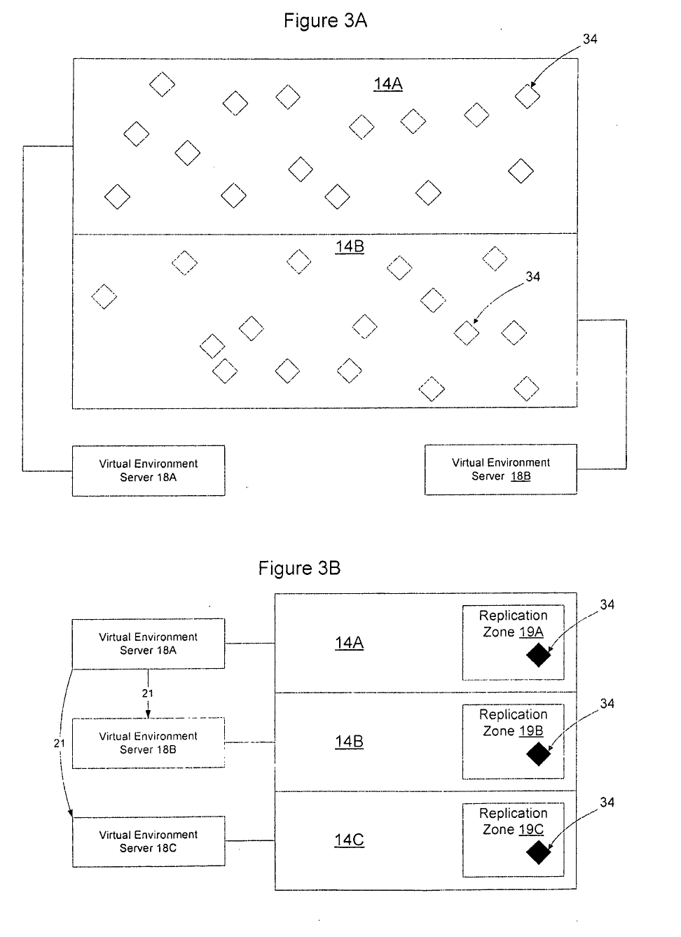

FIG. 3A is a two dimensional view of users in an example three dimensional computer-generated virtual environment implemented using multiple servers, each of which is responsible for users in a particular region of the virtual environment. FIG. 3B shows the same type of virtual environment in which a replication zone 19 is located within each region of the virtual environment. As shown in FIG. 3A, a virtual environment 14 may have region 14A, 14B, each of which is supported by a corresponding virtual environment server 18A, 18B. Each virtual environment server 18A, 18B is thus responsible for a particular region and all users present within the region of the virtual environment. Since the number of users that a particular server may support is limited by the processing power of the server, each region 14A, 14B has an occupancy limit.

Where replication zones span between slices, the replication zone in each slice is required to be the same size, shape, etc., so that an Avatar does not violate any rules of one of the servers. For example, if one of the replication zones on one of the servers is smaller than a corresponding replication zone on another server, the Avatar may walk through a wall or walk off the stage in the smaller replication zone which could cause the Avatar to violate a rule of that server. Thus, preferably, associated replication zones are identical in all instances and in all slices. Obviously, where there are different replication zones that are unaffiliated, the unaffiliated replication zones are not required to be identical since the unaffiliated replication zones are not causing replication between each other.

It may be desirable for one person or a group of people to provide information to more people than can be located within a particular region. For example a conference may have a panel of experts that are convened to discuss a particular topic. If a region 14A has an occupancy limit that prevents everyone from attending the conference, some users of the virtual environment will not be able to attend the conference.

According to an embodiment of the invention, as shown in FIG. 3B, a replication zone may be defined in multiple regions of the virtual environment. The replication zone may be accessed from a particular region or, alternatively, may be accessed from any region. When a user enters a replication zone they are replicated to all other zones. When they exit the replication zone they return to the original server (region) where they were before entering the replication zone, or if supported, the user may specify a new instance/region to be used as an exit region.

Objects and Avatars within the replication zone are replicated to all other replication zones so that they visible in more than one region. Thus, returning to our conference example, if the panel of experts were to enter the replication zone in region 14A, the identical content will be replicated to the other replication zones 14B, 14C, so that the Avatars representing the panel of experts would be visible to Avatars in each of the regions containing an instance of the replication zone. Thus, Avatars in the other regions may be provided with the same presentation as is being provided to the Avatars in the primary region 14A. The experts could also enter from different regions and, while in the replication zone, each expert could see the other experts in the replication zone and those Avatars present in the zone from which it entered. Upon conclusion of the panel, each Avatar may return to its entry region. The user may also specify that they would like to exit into a different zone and, upon exiting the replication zone, the user will be assigned to the server for the new region/instance.

Since the replication zone causes replication of the content of the replication zone to occur at different locations within the virtual environment, Avatars are not required to converge on a single point in the virtual environment to see what is occurring within the replication zone. For example, the panel of experts may simultaneously appear in a ballroom or lecture hall in two or more areas of the virtual environment. Since the replication will occur in multiple regions supported by different virtual environment servers, more people will be able to have access to the presentation than would otherwise be possible using a single location.

The replication zone may be identified as a volume in the virtual world. Replication zones may have one or more associated discontiguous replication areas and are not required to be implemented using contiguous volumes in the virtual world. In operation, a designer would define one or more arbitrary volume shapes in the virtual environment and define, as an attribute, that the volume or set of volumes constitute a replication zone. Where the zone is implemented as two or more discontiguous volumes, the volumes may be linked.

The designer may specify access controls for the shape, entrance/exit areas for the volume, permanent objects to be included within the volume, and specify the type of objects that may be brought into the volume. Access may be implemented in any desired manner, such as by defining who may enter the replication zone, when the replication zone may be accessed, requiring the user to have an invitation to enter the replication zone, and other similar properties. Thus, for example, the replication zone may be secured such that only authorized users/Avatars may enter the replication zone.

The designer would also identify locations within the virtual environment where the replication zones should be placed. For example, the replication zone may be a stage in a virtual auditorium. Similar auditoriums may exist in other areas of the virtual environment. The designer may specify that each of the stages is a replication zone and link the replication zones together to associate a replication zone in one region with associated replication zones in one or more other regions. All objects in one replication zone will be replicated to the other associated replication zones in other regions of the virtual environment.

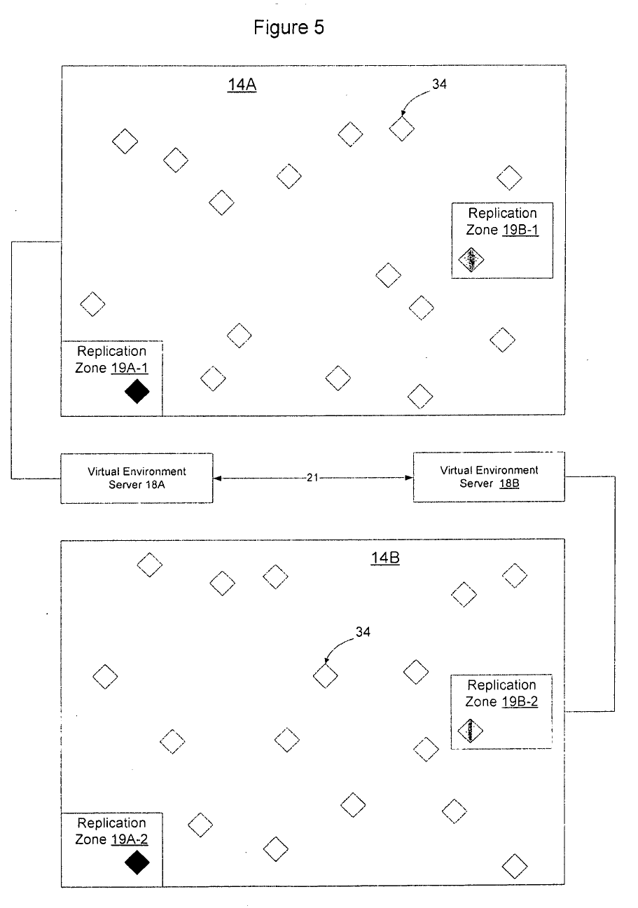

Not all replication zones are required to be linked together. Thus, there may be multiple different replication zones, sets of which may be related to each other and unrelated to other sets. For example, as shown in FIG. 5, a first set of replication zones 19A-1 and 19A-2 may be linked together and a second set of replication zones 19B-1 and 19B-2 may be linked together. Objects and Avatars in replication zone 19A-1 will be replicated to replication zone 19A-2, but will not be replicated to replication zones 19B-1 or 19B-2. Likewise, objects and Avatars in replication zone 19B-1 will be replicated to replication zone 19B-2, but will not be replicated to replication zones 19A-1 or 19A-2.

Where the virtual environment is instanced, by default it is envisioned that each instance of the virtual environment will have identical replication zones. However, it may be possible to define the replication zone such that it only exists across a subset of the instances. This may be possible, for example, by linking the replication zones in a first set of servers together while not linking that replication zone with other servers supporting other instances.

An Avatar in a replication zone will only be able to see other Avatars and objects in the replication zone and Avatars in the region where the user entered the replication zone (referred to herein as the entry region), even though a representation of the Avatar will be reproduced across the other replication zones in the other regions. Thus, for example, if an Avatar 34 entered replication zone 19A from region 14A, the Avatar 34 would be able to see other Avatars in the replication zone and other Avatars located in the entry region 14A. Avatars in regions 14B and 14C would also be able to see the Avatar 34 but Avatar 34 would not be able to see them. Alternatively, the user who's Avatar is in the replication zone may be given a smaller lower bandwidth (fewer frames per second) view into the other regions/instances to enable the user to also see Avatars in regions 14B and 14C. These views may be implemented in the same window as the virtual environment client or in one or more separate windows.

When an Avatar is in a replication zone, actions of the Avatar will need to be sent to each of the virtual environment servers hosting a region/instance with an associated replication zone. There are several ways of handling replication.

The client may broadcast Avatar actions to each of the servers. In this embodiment, when a user causes their Avatar to enter a replication zone, the virtual environment client will send the Avatar's actions to all servers in the zone, but only receive data from the server hosting the entry region. This allows every virtual environment server to receive data associated with the Avatar's actions. It also does not add latency as each virtual environment server is receiving input directly from the client. Implementation of this embodiment relies on changes to the virtual environment client rather than at the virtual environment server. A drawback is that the user is required to transmit data on multiple upstream connections (one to each of the servers) which impacts scalability. This may also introduce synchronization issues as no server is the master.

Another option is to use the entry server (the server responsible for the region/instance where the user entered the replication zone) as the master. In this option, the virtual environment client sends and receives data only to/from the entry server. Thus, the user is not required to transmit similar data to multiple servers. The entry server acts as the master and ensures that all of the other servers are synchronized. Having the entry server act as the master will introduce some latency for all but the entry server. For the client, this solution is advantageous in that it does not increase the client bandwidth and, hence, scales better. Also, no client code changes are required and clients are not required to change servers or interact with any server other than the entry server, which is the server that they were working with before entering the replication zone. Using an entry server as the master may present a problem where there are multiple users of the replication zone which have all entered from different entry servers, however. In this instance, there may be multiple master servers which may cause conflict between the servers.

Another option is to designate a particular server as the master for each replication zone. The master may be one of the servers serving a replication zone or an independent virtual environment server that is only responsible for maintaining the replication zones. When an Avatar enters a replication zone, the virtual environment client will switch servers to talk to the master server for the replication zone. The virtual environment client will then send data to the master server, which handles sending data for the replication zone to all other servers. This option requires both client and server code to be modified, and does add some additional latency for all servers except the master server. As with the second option, since the client is only talking to one server, entry of the Avatar into a replication zone will not require additional client bandwidth and, hence, will scale better. This option also avoids multi-master synchronization issues since all Avatars that are in the replication zone will interact with the same master server.

Since the Avatar 32 is replicated to other servers 18 when the Avatar uses the replication zone, the user will occupy one available slot on each of the servers where the user's Avatar is replicated. For example, assume that each server 18A, 18B, 18C, can host 100 users and render 100 Avatars. When an Avatar enters the replication zone 19A from region 14A, that Avatar will be replicated to each of the other replication zones 19B, 19C in each of the other regions 14B, 14C. The servers 18B, 18C will need to render the Avatar within the replication zone of the region and, accordingly, the presence of the Avatar in the replication zones will occupy one of the available slots on each of the servers where the replication occurs. Thus, rather than being able to host 100 users, each of the servers 18B, 18C will be able to host the Avatar 32 and 99 other users.

Generally, servers are configured to allow a number of users onto the server which is lower than the maximum capacity for the server. Thus, it may be expected that the servers would have sufficient buffer capacity to enable replicated users to be included in the various regions of the virtual environment. If a particular server does not have sufficient capacity, however, the user will not be allowed to enter the replication region. Optionally, each server may reserve a particular number of allocations depending on the number of users that may enter the replication zones supported by that server. Thus, where there is a 30 person replication zone in one virtual environment supported by the server, for example for a large conference, the server would reserve 30 allocations to accommodate the anticipated 30 Avatars in the replication zone. Similarly, if the virtual environment supported by the server included ten 3 person replication zones, i.e. in connection with booths at a trade show, the virtual environment server would once again reserve 30 allocations to accommodate the anticipated 30 Avatars in the several supported replication zones.

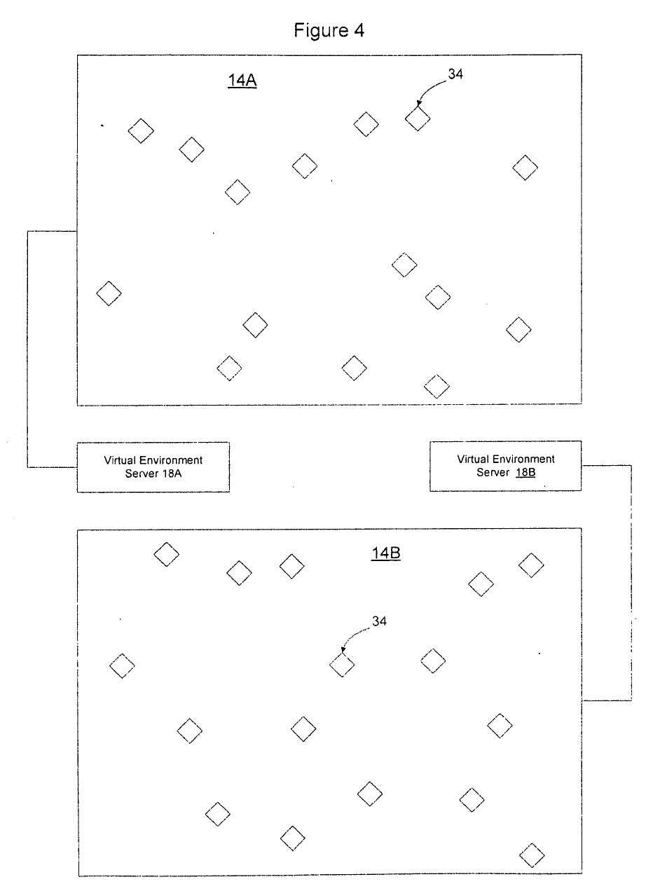

FIG. 4 shows a two dimensional representation of Avatars in an example computer-generated virtual environment implemented using multiple servers, each of which is responsible for maintaining a full instance of the virtual environment and is responsible for a subset of the total users of the virtual environment. FIG. 5 is a similar view, but showing how replication zones may be used to enable objects to be visible and present in the multiple instances of the virtual environment simultaneously.

As shown in FIG. 4, rather than having each server 18A responsible for a particular region of the virtual environment, each server 18A, 18B can instead render an entire instance of the virtual environment. Since each server can only handle a particular number of users, each server is responsible for a subset of the total number of users of the virtual environment. Commonly these are referred to as worlds. In use, a user will log into a particular world of the virtual environment. The user will only be able to interact with other users that have logged into the same world and will not have interaction with users in other worlds.

As shown in FIG. 5, a replication zone may be defined to span between the worlds such that whatever enters the replication zone in one world will be replicated in associated replication zones in all of the other worlds. Although it is currently contemplated that the replication zone will be located at the same place within each of the worlds, the replication zone may be placed at different locations in the different worlds where the worlds implemented by the virtual environment servers are not identical. For example, users may build houses and other structures in their instances of the virtual environment. In this and other instances, the replication zones may be sited in somewhat different locations in the different worlds.

As shown in FIGS. 3 and 5, the virtual environment servers 18A, 18B, 18C, communicate with each other to enable replication of the content of the replication zone to be consistent across the multiple regions or iterations. This is illustrated by the arrow 21 extending between virtual environment servers 18A and 18B in FIG. 5, and by the arrows 21 extending between virtual environment servers 18A and 18B, and between virtual environment servers 18A and 18C of FIG. 3.

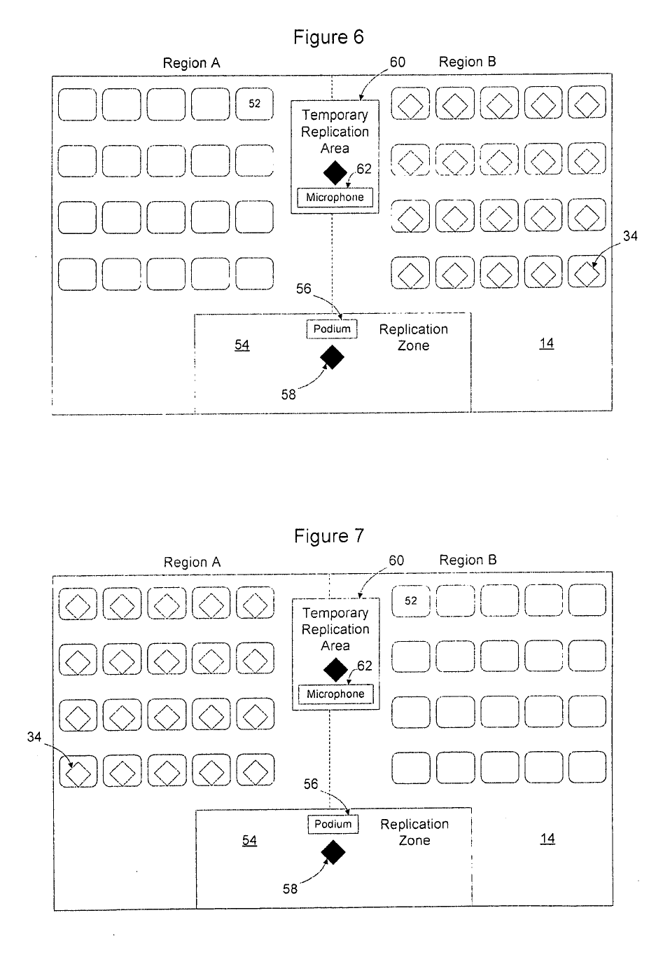

FIGS. 6-7 and 8-9 show a practical example of how replication zones may be used in a virtual environment. In each figure, the virtual environment has been implemented as a auditorium 50 containing chairs 52 and a stage 54. The stage has been configured as a replication zone. The replication zone includes a podium 56, which is an inanimate object, and an Avatar 58 who will be making a presentation to an audience. Users may attend the presentation by causing their Avatars 60 to enter the auditorium 50 and sit in a chair 52.

FIGS. 6 and 7 show an embodiment where each half of the conference room is implemented by a separate virtual environment server. As shown in FIG. 6, the right half of the auditorium may be implemented by a first virtual environment server hosting a set of users represented by a first set of Avatars. FIG. 7 shows the Avatars maintained by a server implementing on the left half of the auditorium. The replication zone spans between the left and right halves of the auditorium. Hence, the content of the replication zone is visible to each of the Avatars on the left side of the auditorium as well as each of the Avatars on the right side of the auditorium. The Avatars on the left cannot see the Avatars on the right, however, and conversely the Avatars on the right cannot see the Avatars on the left. Thus, the auditorium will look to the Avatars to be half empty. However, each Avatar will be able to see the Avatar 58 representing the presenter that is standing at the podium.

As shown in FIGS. 6 and 7, a second replication zone 60 may be implemented as well to enable members of the audience to ask questions of the presenter. The second replication zone may be a discontiguous part of the main replication zone or implemented as a separate replication zone. Commonly, in the real world, a conference provider will have one or more microphones 62 located within the audience. If a member of the audience has a question for the speaker or a panelist, the audience member may approach the microphone to ask the question. The auditorium may have smaller replication zones set within the audience area in a similar manner that will enable an audience member to be seen in each of the regions, so that other members of the audience can see the Avatar of the user who is asking the question.

As noted above, not all replication zones are associated such that there are parallel replication zones existing between instances/regions. FIGS. 6 and 7 show an example of this. Specifically, as shown in FIGS. 6 and 7, the stage replication zone is unrelated to the microphone replication zone such that replication of the content of one zone does not occur in the other zone. Replication of the content of the replication zone occurs, however, between each region or instance of the virtual environment where an associated replication zone exists. For example, the microphone replication zone may be a discontiguous part of the stage replication zone so that the two areas are actually separate parts of the same replication zone.

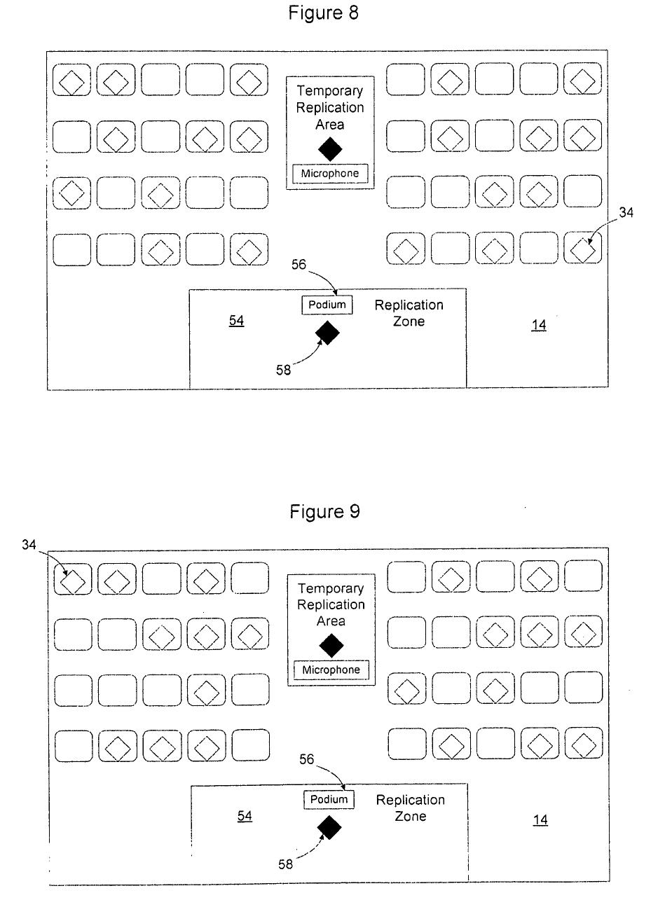

FIGS. 8 and 9 show the same auditorium but show different worlds, each world containing a subset of the total number of users of the virtual environment. In the example shown in FIGS. 8 and 9, the auditorium will not appear to be full in either of the worlds. However, the total number of users may actually fill or overfill the capacity of the auditorium, were all users to be able to attend the presentation in a single world. Similarly, since the worlds are not linked, other than through the replication zone, Avatars in different worlds may occupy the same position in each of the worlds. A presenter on the stage would see only those Avatars that are located in the world where the presenter entered the replication zone. Other Avatars in the other worlds would not be visible to the presenter. However, as with before, a second replication zone 60 may be provided in the audience area of the auditorium to enable a member to appear within each world while the Avatar asks a question. When the Avatar enters the second replication zone (microphone replication zone) the audience member Avatar will be visible in all related replication zones and, hence be visible to the presenter as well as to the other audience members. Of course, the presenter may have multiple clients open to enable the presenter to see Avatars in other related worlds as well.

The preceding discussion has focused on replication of the Avatar's image within multiple regions or multiple iterations of the virtual environment. Audio produced by the objects within the replication zone will similarly be replicated within the regions/iterations as well. According to an embodiment of the invention, audio originating from an object within the replication zone may be provided to Avatars within hearing distance of the replication zone as if it was produced in their region/instance in a normal manner. Sound may be implemented by mixing audio from the Avatar in the replication zone into audio streams for users within each region/iteration that are within hearing distance of their respective replication zone.

Normally, sound tapers off with distance such that users with Avatars that are farther away are quieter than users with Avatars that are closer. This enables a user to hear people better when their Avatar is closer to the user's Avatar in the virtual environment. Optionally, the distance associated with communication from the replication zone may be extended as if the audio from the replication zone were produced using a microphone and Public Address (PA) system. Enabling all users within a particular zone or area of the virtual environment to hear audio from a user will be referred to herein as OmniVoice. When a user is speaking from the replication zone the user may invoke OmniVoice by default.

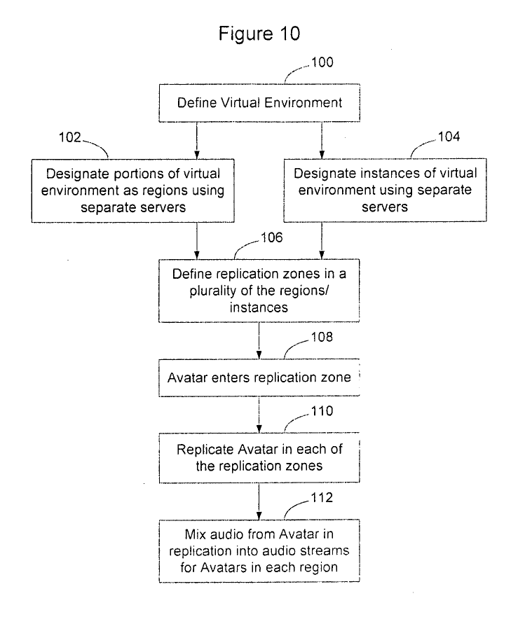

FIG. 10 shows a flow chart of a process, portions of which may be used by one or more entities, to enable an Avatar and/or objects to be replicated across multiple regions or instances of a virtual environment supported by separate virtual environment servers. As shown in FIG. 10, the virtual environment will be defined (100) to include the environment through which the users will navigate their Avatars. There are many ways of defining an environment and, as mentioned above, virtual environments may be used for a multitude of purposes. For example, the virtual environment may be defined using programming techniques such as defining volumes in the virtual environment and assigning attributes and textures to the volumes. The replication zone may be defined as a volume, with the replication feature specified as an attribute of the volume. Many different ways of creating a virtual environment may be possible and the invention is not limited to the use of any particular programming technique. Additionally, this step may be repeated over time to refine the virtual environment based on feedback from the users of the virtual environment, to upgrade the virtual environment, or otherwise.

Separate virtual environment servers will render individual portions of the virtual environment as regions of the virtual environment (102). Alternatively, separate virtual environment servers will render separate instances of the virtual environment as worlds (104). Optionally, both regions and instances may be used in which sets of virtual environment servers are used to implement particular regions of an instance of a virtual environment world.

While defining the virtual environment or as part of the revising process, individual portions of the virtual environment may be rendered as replication zones. The replication zones may span between regions or instances (106), such that a single replication zone may be supported by multiple servers. Optionally, the replication zones may span within a particular region or within a particular instance to enable the content of a replication zone to be seen at multiple places within the same region/instance.

When an Avatar enters the replication zone (108) the Avatar will be replicated in each of the associated replication zones (110). Thus, Avatars within each of the regions/instances will be able to see the Avatar in the replication zone. Additionally, audio produced by the Avatars and other objects within the replication zone will be included in audio streams for Avatars in each of the regions/instances that is associated with the replication zone (112).

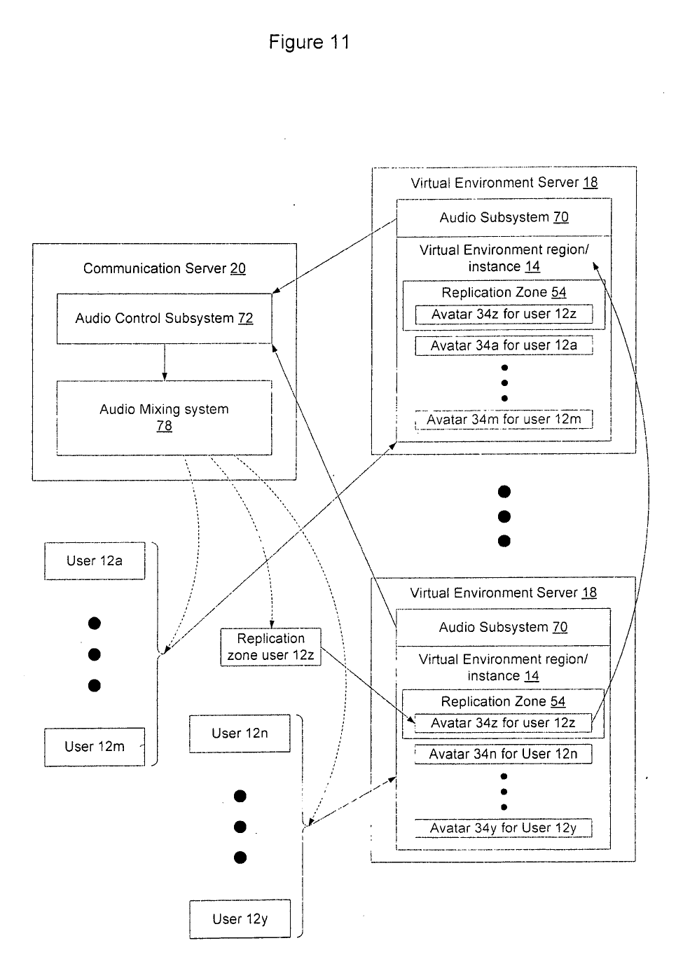

FIG. 11 shows the system that may be used to implement replication zones within a virtual environment according to an embodiment of the invention. As shown in FIG. 11, users 12 are provided with access to a virtual environment 14 that is implemented using a plurality of virtual environment servers 18. Each virtual environment server 18 will implement a region of the virtual environment or an instance of the virtual environment. It will be assumed that the virtual environment includes one or more replication zones that span between regions/instances and enable objects/avatars to be replicated between regions/instances.

Users will be represented by avatars 34 within the virtual environment. When one or more of the users such as user 34z enters a replication zone 54, the Avatar 34z for that user is replicated in each of the corresponding replication zones 54 in each of the regions/instances by the corresponding virtual environment servers 18.

The virtual environment servers may also implement an audio subsystem 70 to control communication between users of the virtual environment. The audio subsystem may control the establishment of voice communication sessions between the users which may be established via a communication server 20. The communication server may be implemented as a separate server or may be implemented as a process in one of the virtual environment servers.

As shown in FIG. 11, the communication server 20 includes an audio control subsystem 72 designed to mix audio to be presented to users. In operation, the virtual environment server will detect that sets of users should be able to hear each other within the virtual environment. The communication server will receive audio from the users of the virtual environment and an audio mixer 78 will mix individual audio streams for each user to include audio from other users that the user should be able to hear. Where a user has invoked OmniVoice, the audio from that user will be mixed into the audio stream for all other users within the region.

In the previous discussion it was assumed that the Avatar was required to enter into a replication zone to be replicated across instances/slices of the virtual environment. In another embodiment the Avatar may be required to possess a particular object. Still alternatively, the user may be allowed to invoke replication by accessing a control on a menu to cause the Avatar to be replicated across slices/instances without entering a particular replication zone. In this instance, the volume defining the Avatar itself is considered the replication zone, which is then replicated across the slices/instances.

The functions described above may be implemented as one or more sets of program instructions that are stored in a computer readable memory and executed on one or more processors within on one or more computers. However, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, a state machine, or any other device including any combination thereof. Programmable logic can be fixed temporarily or permanently in a tangible medium such as a read-only memory chip, a computer memory, a disk, or other storage medium. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of enabling a user's presence to be replicated within a virtual environment supported by separate virtual environment servers, to enable the user's presence to be experienced by a larger number of fellow users of the virtual environment than are able to be hosted by a single virtual environment server, the method comprising the steps of:
determining that an Avatar associated with the user is present in a replication zone within the virtual environment supported by a first of the virtual environment servers; and
causing the Avatar associated with the user to be replicated in a corresponding replication zone in the virtual environment supported by a second of the virtual environment servers.

2. The method of enabling a user's presence to be replicated within a virtual environment of claim 1, wherein the virtual environment is an instanced virtual environment, in which each of the virtual environment servers supports an instance of the virtual environment.

3. The method of enabling a user's presence to be replicated within a virtual environment of claim 1, wherein the virtual environment is a sliced virtual environment, in which each of the virtual environment servers supports a region of the virtual environment.

4. The method of enabling a user's presence to be replicated within a virtual environment of claim 1, wherein the replication zone and all corresponding replication zones are identical to each other.

5. The method of enabling a user's presence to be replicated within a virtual environment of claim 1, wherein the replication zone is a contiguous volume.

6. The method of enabling a user's presence to be replicated within a virtual environment of claim 1, wherein the replication zone has two or more discontiguous volumes.

7. The method of enabling a user's presence to be replicated within a virtual environment of claim 1, wherein the virtual environment contains multiple sets of associated replication zones, such that objects and Avatars within a first set of associated replication zones are internally replicated within all associated replication zones in that set, but are not replicated to replication zones associated with other sets of associated replication zones.

8. The method of enabling a user's presence to be replicated within a virtual environment of claim 1, wherein the user has a virtual environment client interacting with the first virtual environment server and not with the second virtual environment server.

9. The method of enabling a user's presence to be replicated within a virtual environment of claim 8, wherein the first virtual environment server conveys data associated with the Avatar to the second virtual environment server.

10. The method of enabling a user's presence to be replicated within a virtual environment of claim 1, wherein the user has a virtual environment client that provides data to both the first virtual environment server and to the second virtual environment server.

11. The method of enabling a user's presence to be replicated within a virtual environment of claim 1, wherein the user has a virtual environment client that provides data to a separate virtual environment server responsible for handling Avatars and objects located within the replication zone.

12. The method of enabling a user's presence to be replicated within a virtual environment of claim 1, wherein the step of causing the Avatar associated with the user to be replicated comprises causing the Avatar appearance and location to be replicated such that the Avatar appearance and location within the replication zone is identical in the virtual environment supported by the first virtual environment server and in the virtual environment supported by the second virtual environment server.

13. The method of enabling a user's presence to be replicated within a virtual environment of claim 1, wherein the step of causing the Avatar associated with the user to be replicated comprises causing audio from the user to be replicated as well.

14. The method of enabling a user's presence to be replicated within a virtual environment of claim 13, wherein the step of causing audio from the user to be replicated comprises causing audio generated by the user associated with the Avatar to be included in audio streams of clients of the first virtual environment server and also to be included in audio streams of clients of the second virtual environment server.

15. The method of enabling a user's presence to be replicated within a virtual environment of claim 13, wherein the step of causing audio from the user to be replicated comprises mixing the audio from the user into audio streams of all users of the virtual environment using OmniVoice.

16. The method of enabling a user's presence to be replicated within a virtual environment of claim 13, further comprising the step of reserving space for Avatars on each of the virtual environment servers according to a capacity of the replication zone, the capacity of the replication zone referring to a maximum number of users that may enter the replication zone at a particular time.

17. The method of enabling a user's presence to be replicated within a virtual environment of claim 1, wherein the Avatar associated with the user entered the replication zone from the virtual environment supported by the first of the virtual environment servers.

18. The method of claim 17, further comprising requiring the Avatar to exit the replication zone into the virtual environment supported by the first of the virtual environment servers when the user elects to no longer remain within the replication zone.

19. The method of claim 17, further comprising allowing the user to elect whether the Avatar should exit the replication zone into the virtual environment supported by the first of the virtual environment servers or should exit the replication zone into the virtual environment supported by the second of the virtual environment servers when the user elects to no longer remain within the replication zone.
